(19) United States
(12) Patent Application Publication
(10) Pub. No.: US 2021/0224669 A1
(43) Pub. Date: Jul. 22, 2021

(54) SYSTEM AND METHOD FOR PREDICTING HYDROCARBON WELL PRODUCTION

(71) Applicant: Veld Applied Analytics, Houston, TX (US)

(72) Inventors: Seong Taek Chung, Houston, TX (US); Rollyn Reyes, Houston, TX (US)

(21) Appl. No.: 17/153,542

(22) Filed: Jan. 20, 2021

Related U.S. Application Data
(60) Provisional application No. 62/963,288, filed on Jan. 20, 2020.
(60) Provisional application No. 63/000,766, filed on Mar. 27, 2020.

(51) Int. Cl. G06N 5/04; G06N 20/00; E21B 49/08

(52) U.S. Cl. CPC G06N 5/04; E21B 2200/22; E21B 49/087; G06N 20/00

(57) ABSTRACT

A method includes applying a production prediction algorithm to one or more parameters for a hydrocarbon well to generate a production decline curve for the hydrocarbon well. The production prediction algorithm has a start time and an end time, and the production decline curve comprises predicted production data. The method also includes comparing the predicted production data for a time period between the start time and the end time to historical production data for the hydrocarbon well from the time period; and determining a prediction accuracy metric for the hydrocarbon well based on the comparison.

### CROSS-REFERENCE TO RELATED APPLICATIONS

This application claims priority to U.S. Provisional Patent Application No. 62/963,288 filed Jan. 20, 2020 and to U.S. Provisional Patent Application No. 63/000,766 filed Mar. 27, 2020, both of which are hereby incorporated herein by reference in their entirety.

### BACKGROUND

Assets may be securitized and sold to investors. One resulting security is an asset-backed security, which is a security having its value derived from and collateralized (or “backed”) by a group of underlying assets. In some cases, the underlying assets may be illiquid and/or difficult to sell individually.

A wellbore asset refers to a property interest in a hydrocarbon well, or rights entitling the owner thereof to hydrocarbons produced from the well. In some cases, wellbore assets may be securitized. For example, wellbore assets may be grouped into an asset-backed security, used as collateral for a term loan, or sold as an equity.

### SUMMARY

In accordance with at least one example of the disclosure, a method includes applying a production prediction algorithm to one or more parameters for a hydrocarbon well to generate a production decline curve for the hydrocarbon well. The production prediction algorithm has a start time and an end time, and the production decline curve comprises predicted production data. The method also includes comparing the predicted production data for a time period between the start time and the end time to historical production data for the hydrocarbon well from the time period; and determining a prediction accuracy metric for the hydrocarbon well based on the comparison.

In accordance with another example of the disclosure, a system includes a processor and a storage device coupled to the processor. The storage device is configured to store instructions that, when executed by the processor, configure the processor to apply a production prediction algorithm to one or more parameters for a hydrocarbon well to generate a production decline curve for the hydrocarbon well. The production prediction algorithm has a start time and an end time, and the production decline curve comprises predicted production data. The instructions, when executed by the processor, further configure the processor to compare the predicted production data for a time period between the start time and the end time to historical production data for the hydrocarbon well from the time period; and determine a prediction accuracy metric for the hydrocarbon well based on the comparison.

In accordance with yet another example of the disclosure, a non-transitory computer-readable medium is encoded with instructions that, when executed, cause a processor to be configured to apply a production prediction algorithm to one or more parameters for a hydrocarbon well to generate a production decline curve for the hydrocarbon well. The production prediction algorithm has a start time and an end time, and the production decline curve comprises predicted production data. The instructions, when executed by the processor, further configure the processor to compare the predicted production data for a time period between the start time and the end time to historical production data for the hydrocarbon well from the time period; and determine a prediction accuracy metric for the hydrocarbon well based on the comparison.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of exemplary embodiments, reference will now be made to the accompanying drawings, which may not be drawn to scale, in which:

FIG. 1 is a block diagram of a prediction system for determining an accuracy metric of a prediction of hydrocarbon well performance in accordance with examples described herein;

FIG. 2 is a block diagram of a computing system including a computing device configured for use in the prediction system of FIG. 1 and in accordance with examples described herein;

FIG. 3 is an example of a package of wells being grouped into first and second pods in accordance with examples described herein;

FIG. 4 is a graphical example of a multi-segment event in accordance with examples described herein;

FIG. 5 is a graphical example of residual error between historical production data and a predicted production decline curve in accordance with examples described herein;

FIG. 6 is a graphical example of the functionality of the backtesting engine in accordance with examples described herein; and

FIG. 7 is a flow chart of a method for determining an accuracy metric of a prediction of hydrocarbon well performance in accordance with examples described herein.

### NOTATION AND NOMENCLATURE

In the following discussion and in the claims, the terms “including” and “comprising” are used in an open-ended fashion, and thus should be interpreted to mean “including, but not limited to . . . ”. Any use of any form of the terms “connect”, “engage”, “couple”, “attach”, or any other term describing an interaction between elements is not meant to limit the interaction to direct interaction between the elements and may also include indirect interaction between the elements described. The term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of additional factors.

In this description, “return on investment” or “ROI” may refer refers to a performance measure that is used to evaluate the efficiency of an investment.

In this description, “well performance” may refer to a metric to evaluate a well. For example, well performance metrics may include initial rate (or decline in rate) of hydrocarbon production, final rate (or decline in rate) of hydrocarbon production, lifetime total hydrocarbon production, the net present value of the lifetime hydrocarbon production, or return on investment (ROI) from hydrocarbon production.

In this description, “well parameters” may refer to well location (e.g., wellhead latitude and longitude, average horizontal section depth), borehole parameters (e.g., geometry), and production parameters (e.g., historical production data). A well identifier (ID) may be associated with a group of well parameters for a given hydrocarbon well.

### DETAILED DESCRIPTION

In the drawings and description that follow, like parts are typically marked throughout the specification and drawings with the same reference numerals. The drawing figures are not necessarily to scale. Certain features of embodiments may be shown exaggerated in scale or in somewhat schematic form, and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings and components of the embodiments discussed below may be employed separately or in any suitable combination to produce desired results.

Hydrocarbon production is a costly process and includes numerous expensive activities. An operator typically acquires acreage in a hydrocarbon-producing area (e.g., a hydrocarbon field) and drills a well into at least one hydrocarbon-bearing zone of a reservoir. Completion of the well is then conducted in a manner that is conducive to the removal of hydrocarbons from the reservoir and the transportation of the hydrocarbons to the surface. In some cases, it is useful to the operator to recoup some of its initial costs by monetizing the hydrocarbon production (or portions thereof) from a completed hydrocarbon well.

As explained above, wellbore assets may be grouped into one or more asset-backed securities or into a special purpose vehicle (SPV) without being securitized. In some cases, different investors have different investment needs. For example, investment horizons may differ among investors, with some investors seeking short-term investment instruments and other investors seeking long-term investment instruments. In another example, risk criteria may differ among investors. Therefore, the ability to quantify the risk of wellbore assets is useful.

It is also useful to accurately evaluate the value of the underlying asset(s) (e.g., wellbore assets), for example to quantify the value and/or risk associated with an asset-backed security or non-securitized SPV that includes those underlying assets, or to determine whether to include a particular underlying asset in the group of underlying assets that make up the asset-backed security or non-securitized SPV.

Examples of this disclosure include predicting or forecasting future hydrocarbon production for a given well or group of wells based on historical production data for the well or group of wells. Other examples of this disclosure include predicting or forecasting future hydrocarbon production additionally or alternately based on well spacing (or the distance between a well being analyzed and other wells already analyzed), completion data for the well being analyzed (or other wells in the vicinity of the well being analyzed), and/or other parameters or data for the well being analyzed. The predicted future hydrocarbon production for a well may be used to evaluate or determine a value for that well in order to include the wellbore asset in an asset-backed security or non-securitized SPV as described above.

Although numerous methods exist to predict or forecast data (e.g., predicted production data for a hydrocarbon well) based on historical data (e.g., historical production data for the hydrocarbon well) or other data for the well as described above, when evaluating a wellbore asset (e.g., to securitize the wellbore asset), it is useful to be able to determine, and thus provide to investors, an accuracy metric or confidence level in the predicted production curve for the hydrocarbon well. In one example, the accuracy metric is represented as a standard deviation value of the predicted production curve versus an actual production curve. Thus, examples of this disclosure also include determining an accuracy metric for a predicted production curve for a well based on a comparison of a predicted production curve for a time period (e.g., in the past) with historical production data for that well for the same time period. Determining the accuracy metric over different time periods may be useful in different applications. For example, determining the accuracy metric over a shorter time period (e.g., 2 years) is useful to confirm whether the current prediction or forecast methodology is accurate for up-to-date (e.g., more recent) production data. As another example, determining the accuracy metric over a longer time period (e.g., 8 years, 10 years, or more) is useful to confirm that the current prediction or forecast methodology is accurate for a relatively large amount of historical data, and thus displays predictive ability having sufficient longevity characteristics.

In some examples, the predicted production curve in conjunction with the determined accuracy metric are also useful to provide an insurance product that provides its holder insurance against a production volume for a given well or group of wells that falls below a lower production threshold for that well or group of wells. In the example of such a volume insurance product application, determining the accuracy metric over a time period that corresponds with a time period of the volume insurance product is useful. For example, if the volume insurance product provides its holder insurance against a production volume for a well or group of wells falling below a lower production threshold in the subsequent 4 years, it is useful to determine the accuracy metric over a 4-year time period as well. These and other examples are described in further detail below.

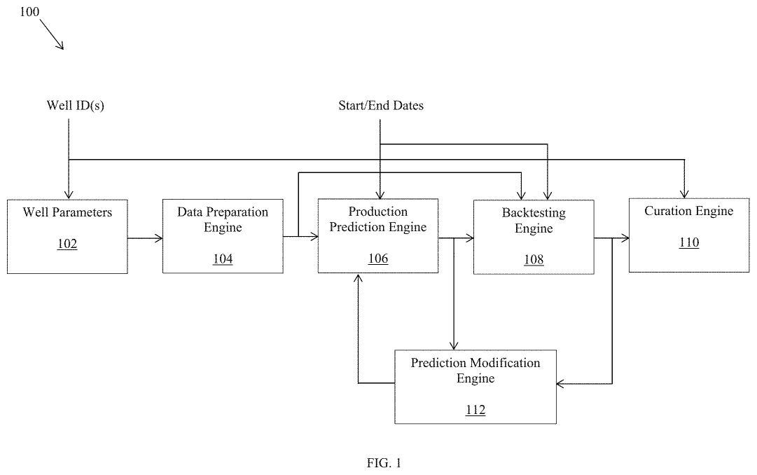

FIG. 1 is a block diagram of a system 100 in accordance with examples of this description. The system 100 is a prediction system 100 for determining an accuracy metric of a prediction of hydrocarbon well performance. The prediction system 100 includes various engines (e.g., software executing on one or more computing devices) that perform functionality as described herein. In some examples, certain of the engines shown in FIG. 1 may be omitted, while in other examples, functionality beyond the engines shown in FIG. 1 may be included. Embodiments of this description are thus not limited solely to the illustrative implementation shown in FIG. 1.

In the example of FIG. 1, the prediction system 100 includes well parameters 102, a data preparation engine 104, a production prediction engine 106, a backtesting engine 108, a curation engine 110, and a prediction modification engine 112. The well parameters 102 may be implemented as a database containing well parameters (e.g., data) for one or more hydrocarbon wells. The well parameters 102 may include well location (e.g., wellhead latitude and longitude, average horizontal section depth), borehole parameters (e.g., geometry), and production parameters (e.g., historical production data) for one or more hydrocarbon wells. In some examples, the well parameters 102 include data sufficient to generate a predicted decline curve for a given well. In particular, the well parameters 102 may also include historical monthly production volume(s) for oil, gas, and/or water; days on production for the well; true vertical depth (TVD); and lateral length.

In this example, a well identifier (ID) is associated with a group of well parameters for a given hydrocarbon well. The well parameters 102 may be implemented as a publicly-accessible database (e.g., containing public data pertaining to the hydrocarbon wells), may be implemented as a private database (e.g., maintained internally by an operator), or may be a combination of public and private databases.

The well parameters 102 (e.g., for a given well ID or well IDs) are provided to the data preparation engine 104. In some examples, the well parameters 102 comprise publicly available (e.g., reported by operators to public governing bodies) data or private data from an operator itself. Regardless of the source of the well parameters 102, such data may contain various formatting or other errors. The data preparation engine 104 is configured to remove or otherwise remedy such errors, such as to facilitate subsequent analysis (e.g., by the production prediction engine 106 and the backtesting engine 108).

For example, the data preparation engine 104 is configured to resolve monthly reported negative days on production, reported days on production greater than the number of days in the month, and/or missing or otherwise unavailable days on production. For example, negative days on production or greater than 31 days on production for a given month is classified as erroneous, and it may be assumed that such months include approximately 30.4375 days (e.g., an average number of days per month). The data preparation engine 104 is also configured to classify certain data as erroneous, for example production data that indicates a negative volume of oil, gas, and/or water for a given month. Such data is considered erroneous (e.g., not possible) and it may be assumed that such negative production volumes are 0 for the given month.

The data preparation engine 104 is also configured to resolve discrepancies regarding the initial production date for a given well (e.g., mismatching other publicly available data). In some examples, the data preparation engine 104 is configured to calculate ancillary values related to the well parameters 102, such as average daily production rates per month (e.g., monthly volume divided by days on production) for oil, gas, and/or water for a given well; or a moving average (e.g., a 3-month moving average) of water/gas and/or water/oil ratios for a given well. Other ancillary values for a well, such as surface location, bottomhole location, and lateral length may be obtained by accessing or “scraping” directional surveys, plat maps, or other types of publicly available documentation. In some examples, the data preparation engine 104 is configured to resolve double entries in the well parameters 102 (e.g., by removing an extraneous entry for a given date in the historical data for a given well), the rules for removal of which may vary by state. The data preparation engine 104 is also configured to apply shut-in correction in some examples.

In other examples, the data preparation engine 104 is configured to estimate well fracturing (e.g., fracking) completion data, which may be improperly reported or unreported, causing gaps in fracking completion data. For example, the fracture intensity for a well is given by the fracturing proppant mass divided by the lateral length of the well being fracked. However, in some cases, the fracture intensity is not available for a given well. In these cases, the data preparation engine 104 may estimate the fracture intensity for the given well as the median fracture intensity of a certain group of offset wells. In a first example, the certain group of offset wells includes offset wells within six miles of the given well, having first production dates within 12 months of the given well's first production date, and having the same original operator as the given well. In a second example, the certain group of offset wells includes offset wells within six miles of the given well, having first production dates within 12 months of the given well's first production date, and regardless of original operator. In a third example, the certain group of offset wells includes offset wells within six miles of the given well that have the same original operator as the given well. In a fourth example, the certain group of offset wells includes all offset wells within six miles of the given well. In a fifth example, the certain group of offset wells includes all offset wells in the same basin as the given well.

In some examples the data preparation engine 104 is configured to determine a break between segments of a multi-segment historical production dataset. In some examples, such a break or deviation is caused by fracking or re-fracking the hydrocarbon well, which results in a rapid and/or sudden change in production level of the well. In a first example, the data preparation engine 104 is configured to detect such a break or deviation and discard or otherwise ignore historical production data occurring before the break or deviation (e.g., from a previous “segment” of the historical production data). In a second example, the data preparation engine 104 is configured to include historical production data occurring over multiple such segments. Regardless, the data preparation engine 104 may be configured to automatically determine or detect an appropriate point in time in the historical production data and discard or otherwise ignore production data occurring before that point in time.

The data preparation engine 104 thus provides cleaned historical data, in which certain errors or inconsistencies are removed relative to the raw historical well parameters 102 received from public and/or private databases. The cleaned historical data is provided by the data preparation engine 104 to the production prediction engine 106 and, optionally, to the backtesting engine 108.

The production prediction engine 106 is configured to generate a production decline curve (e.g., including predicted production data) in response to the cleaned historical data received from the data preparation engine 104. In one example, the production prediction engine 106 generates the production decline curve by fitting an Arps equation (e.g., an Arps hyperbolic to exponential decline curve) to historical production data. The result of applying the Arps equation is the predicted production decline curve, which forecasts oil and/or gas production volumes going forward from a particular start date, based on historical data from prior to the start date.

For example, qi represents an initial production rate, Di represents an initial decline rate, b represents a forecast model curvature (e.g., a b-factor), and Df represents a final decline rate. The production decline curve for production as a function of time (e.g., q(t)) generated by the production prediction engine 106 may take the form of:

$$When t \leq {t}_{transition} , q = \frac{{q}_{i}}{{( 1 + b {D}_{i} t )}^{\frac{1}{b}}}$$

$$When t > {t}_{transition} , q = {q}_{transition} {e}^{- {D}_{f} ( t - {t}_{transition} )}$$

Where tₜᵣₐₙₛᵢₜᵢₒₙ represents the time at which the decline curve transitions from a hyperbolic decline curve to an exponential decline curve. In an example:

$${t}_{transition} = \frac{\frac{{D}_{i}}{{D}_{f}} - 1}{{bD}_{i}}$$

In some examples, minimum and maximum values for the above parameters (e.g., qi, Di, b, and Df) are provided for a well or group of wells (e.g., a basin). These parameters may be derived from the cleaned historical data provided by the data preparation engine 104. The minimum and maximum values for these parameters serve as boundary conditions for predicted production data (e.g., the predicted production decline curve) for a well.

In these examples, the production prediction engine 106 is configured to numerically solve for values of the above parameters (e.g., qi, Di, b, and Df) to reduce or minimize the error between the historical data provided by the data preparation engine 104 and a historical portion of the decline curve. For example, the production prediction engine 106 selects values of qi, Di, b, and Df that generate a decline curve for a time period that corresponds with a time period for which cleaned historical data is available (e.g., received from the data preparation engine 104), in which an error between the generated decline curve for that time period is reduced or minimized when compared to the historical data for that time period. The selected values of qi, Di, b, and Df may then be used to generate the predicted production data, or decline curve, that begins at a given start date and continues until a given end date, or beyond.

In one non-limiting example, it is assumed that historical well parameters 102 are available for a well from two years prior to a present date (e.g., approximately two years of historical data in one example), and the start date for the prediction by the production prediction engine 106 is the present date. The production prediction engine 106 selects values of qi, Di, b, and Df that generate a decline curve for the previous two years, in which an error between the generated decline curve for the previous two years is reduced or minimized when compared to the historical data for the previous two years. Subsequently, the production prediction engine 106 generates a predicted production decline curve using the selected values of qi, Di, b, and Df beginning from the present date (e.g., the start date) and continuing until a specified end date, or beyond.

As described further below, the production prediction engine 106 may also generate the predicted production decline curve to minimize or reduce an error vector based on the log of the residuals between the predicted production decline curve and historical production data (e.g., received from the data preparation engine 104). The production prediction engine 106 may also apply time weighting to the error vector to effectively apply more (e.g., greater) weight to more recent historical production data (e.g., received from the data preparation engine 104). In some examples, the production prediction engine 106 is configured to apply a moving regression to the historical production data to identify outlier data, which may then be ignored or discarded from the error vector, which prevents noisy data from skewing the predicted production decline curve generated by the production prediction engine 106. Further, the production prediction engine 106 may be configured to apply moving Z-scores and/or piecewise linear segmentation to determine or “score” how anomalous a historical production data point is in order to automatically determine a break between segments of a multi-segment historical production dataset. Thus, the production prediction engine 106 is configured to automatically determine or detect an appropriate point in time in the historical production data from which to begin to generate a production decline curve. This automated, multi-segmented approach to decline curve generation is described further below.

In other examples, the production prediction engine 106 generates the predicted production decline curve using other decline curve methodologies known in the art. Regardless of the particular manner in which the production prediction engine 106 generates the predicted production decline curve, the resultant predicted production decline curve provided by the production prediction engine 106 may be used to evaluate a given well, or to determine a well performance metric for the given well. As explained above, well performance metrics may include lifetime total hydrocarbon production, the net present value of the lifetime hydrocarbon production, or ROI from hydrocarbon production for that well. A predicted production decline curve for the given well may be used to calculate some or all of these example well performance metrics. The resulting well performance metric provided by the production prediction engine 106 may be used to facilitate packaging the well (e.g., as a wellbore asset) into an asset-backed security or other non-securitized SPV having similar investment horizon and/or risk characteristics.

Additionally, the resultant predicted production decline curve provided by the production prediction engine 106 may be provided to the backtesting engine 108. As described above, when packaging a wellbore asset into an asset-backed security or other non-securitized SPV, it may be useful to determine (and thus provide to investors) an accuracy metric or confidence level in the predicted production decline curve for the hydrocarbon well.

In the examples of this description, the backtesting engine 108 is configured to determine an accuracy metric for a predicted production decline curve (e.g., provided by the production prediction engine 106) for a well based on a comparison of a predicted production decline curve for a time period (e.g., in the past) with historical production data for that well for the same time period.

In this example, the backtesting engine 108 and the production prediction engine 106 each receives a start date or time, which is a date or time in the past. For the purposes of this example, well parameters 102 are available (e.g., historical production data exists) for dates prior to the start time. Thus, the production prediction engine 106 is useful to generate a predicted production decline curve for a given hydrocarbon well using historical data (e.g., from the data preparation engine 104) prior to the start time, which is itself a date in the past as explained above. In this example, the backtesting engine 108 and the production prediction engine 106 also each receives an end date or time, which may be a date or time up to and including the present. Thus, the predicted production decline curve generated by the production prediction engine 106 is for a time period—bounded by the start and end dates—for which historical data (e.g., well parameters 102) are also available.

The backtesting engine 108 is configured to receive the predicted production decline curve from the production prediction engine 106, and also to receive the historical data (e.g., well parameters 102 cleaned by the data preparation engine 104). The backtesting engine 108 is also configured to compare the predicted production decline curve with the corresponding (e.g., occurring at the same time) historical production data from the same time period. The backtesting engine 108 generates or determines a prediction accuracy (e.g., a metric) based on the comparison of the predicted production decline curve with the corresponding historical production data from the same time period. Thus, the accuracy metric may be used to validate or provide a confidence level in the predicted production data provided by the production prediction engine 106.

In one non-limiting example, it is assumed that a start date is a date two years in the past and the end date is the present. The production prediction engine 106 thus generates a predicted production decline curve for a simulated “future” period of two years, which actually corresponds to the past two years, for which historical data is also available. The predicted production decline curve generated by the production prediction engine 106 for the past two years is provided to the backtesting engine 108, which compares the predicted production decline curve with the historical production data (e.g., received from the data preparation engine 104) for that same time period. The backtesting engine 108 generates an accuracy metric that indicates how relatively close the predicted production decline curve is to the historical production data for that same time period. Other embodiments of this description may include different start and end dates, as well as different time periods between the start and end dates; the two-year time period above is one example time period, and is not meant to be limiting.

For purposes of explanation, it is assumed that an accuracy metric closer to a value of 1 corresponds to a greater accuracy of the predicted production decline curve relative to the historical production data. Conversely, an accuracy metric farther away from the value of 1 corresponds to a lower accuracy of the predicted production decline curve relative to the historical production data. In one example, the backtesting engine 108 determines the accuracy metric by dividing a sum of the predicted production volume (e.g., q_{model}) during the time period by a sum of the historical production volume (e.g., qₕᵢₛₜ) during the time period, as given by:

$$Accuracy = \frac{{\sum }_{Start date}^{End date} {q}_{model}}{{\sum }_{Start date}^{End date} {q}_{hist}}$$

In some examples, for a given well, the backtesting engine 108 determines a prediction accuracy metric that is below a lower threshold value (e.g., the prediction accuracy of the production prediction engine 106 is unsuitably low). Responsive to the prediction accuracy metric being below the lower threshold value, the given well may be removed from an asset package of hydrocarbon wells, such as because the given well would introduce an unsuitable amount of risk to the asset package, because the given well cannot be suitably evaluated or valued, or the like.

In other examples, for a given well, the backtesting engine 108 determines a prediction accuracy metric that is above an upper threshold value (e.g., the prediction accuracy of the production prediction engine 106 is suitably high). Responsive to the prediction accuracy metric being above the upper threshold value, the given well may be included in an asset package of hydrocarbon wells, because the given well is suitably valuable, with sufficient accuracy or certainty, and/or introduces only a tolerable amount of risk to the asset package, or the like.

The lower threshold value and the upper threshold value may be the same value in some examples, while in other examples the values are different. For example, the upper and lower threshold values are equal to 0.5 and thus the relative accuracy determination of the predicted production decline curve is binary. However, in another example, the upper threshold value may be higher (e.g., 0.8), while the lower threshold value may be lower (e.g., 0.2). An accuracy metric for a well that falls between the threshold values may result in additional analysis of that particular well before determining whether to include the well in an asset package, or discard the well from being included in the asset package.

Additionally, in other examples, a second (or more) upper threshold value is greater than a first upper threshold value. Responsive to the backtesting engine 108 determining a prediction accuracy metric that is above the second upper threshold value, the given well may be included in a lower-risk tranche of the asset package. For example, a well for which the production prediction engine 106 is able to generate a predicted production decline curve with relatively high accuracy may be suitable for a inclusion in a lower-risk (e.g., less volatile, higher likelihood of generating a certain ROI) tranche of the asset package.

In an additional example, for a given well, the backtesting engine 108 determines a prediction accuracy metric that is above the upper threshold value (e.g., the prediction accuracy of the production prediction engine 106 is suitably high). At the same time, a predicted production decline curve for the given well indicates a future predicted production volume being below a production threshold value. That is, the backtesting engine 108 determines that the production prediction algorithm is relatively accurate, while the production prediction engine 106 determines that the future production volume of the given well is relatively low. In such a scenario, hydrocarbon production for the given well may be ceased, such as by generating an indication or otherwise instructing the operator to cease production, automatically causing wellsite components to cease production, or the like.

In some examples, the predicted production decline curve from the production prediction engine 106, in conjunction with the determined accuracy metric from the backtesting engine 108, are also useful to provide an insurance product that provides its holder insurance against a production volume for a given well or group of wells that falls below a lower production threshold for that well or group of wells.

In some examples of this description, the curation engine 110 is configured to receive the accuracy metric (e.g., provided by the backtesting engine 108) for a given well and determine whether to include that well in an asset package, or whether to utilize that well to determine or predict production decline curves for other nearby wells (e.g., in a same field or basin as the given well). For example, the curation engine 110 determines whether to include the given well in an asset package based on some or all of the criteria described above, such as whether the prediction accuracy metric for the given well is above or below various thresholds. When a given well is curated out of a package of wells, the accuracy metric (e.g., standard deviation) for the package improves because a well with a lower predicted accuracy metric has been removed from the package. Additional functions of the curation engine 110 are described further below.

In still other examples of this description, the prediction modification engine 112 receives both the predicted production decline curve (e.g., from the production prediction engine 106) and the prediction accuracy metric (e.g., from the backtesting engine 108). In some examples, the prediction modification engine 112 provides feedback to the production prediction engine 106 to alter or improve (e.g., improve the accuracy of) the predicted decline curve(s) data generated by the production prediction engine 106. The prediction modification engine 112 may leverage machine learning techniques to improve the accuracy of the decline curves generated by the production prediction engine 106.

In an example, the prediction modification engine 112 modifies the production prediction algorithm responsive to the predicted production decline curve and the prediction accuracy metric. Subsequently, the production prediction engine 106 applies the modified production prediction algorithm to the parameters for the hydrocarbon well to generate a modified predicted production decline curve. The backtesting engine 108 may then compare the modified prediction production decline curve to the historical production data for the same time period to determine a modified prediction accuracy metric. In this example, modifying the production prediction algorithm by the prediction modification engine 112 improves the modified prediction accuracy metric relative to the initial prediction accuracy metric.

In one example, an expected ultimate recovery (EUR) metric for a given well is useful. The EUR metric may refer to a 30-year cumulative production for that well. The EUR metric is utilized as a boundary condition in conjunction with the qi, Di, b, and Df boundary conditions explained above. For example, the prediction modification engine 112 may utilize a gradient boost decision tree machine learning technique to predict the EUR for a given well. This predicted EUR is then used as the additional boundary condition for wells with less than a certain amount of available historical production data (e.g., 24 months or less) to further improve the accuracy of the predicted decline curve generated by the production prediction engine 106. Additionally, for a given well with sparse historical data (e.g., less than a threshold period of historical production history), the prediction modification engine 112 (or the curation engine 110) may create a predicted production decline curve using surrounding offset well production in conjunction with EUR machine learning techniques to forecast production. For example, k-means clustering is used to cluster wells according to well factors (e.g., qi, Di, b, and Df boundary conditions explained above) and a deep neural network algorithm is applied to predict the production decline curve for the given well based on the evenness of those well factors.

The above description of the prediction system 100 of FIG. 1 generally refers to determinations related to a single hydrocarbon well, or at least a single hydrocarbon well at a time. However, in other examples of this description, the prediction system 100 is also configured to analyze a group or package of wells. For example, the above described functionality of the prediction system 100 is applied to determine prediction accuracy metrics for each well in a group of wells (e.g., the wells in a basin).

For example, well parameters 102 for a group of wells (e.g., for multiple well IDs) are provided to the data preparation engine 104. The data preparation engine 104 is configured to remove or otherwise remedy various formatting or other errors, and thus provides cleaned historical data for the group of wells. The production prediction engine 106 is configured to generate a production decline curve (e.g., including predicted production data) for each well in the group of wells in response to the cleaned historical data received from the data preparation engine 104.

The resultant predicted production decline curves may be used to evaluate the group of wells, or to determine a well performance metric for the group of wells. The backtesting engine 108 is thus configured to determine a prediction accuracy metric for each well in the group of wells based on the resultant predicted production decline curves. An overall prediction accuracy metric for the group of wells (e.g., for the entire basin) may be calculated or determined based on the prediction accuracy metrics for the wells in the group. In an example in which the prediction accuracy metric is a standard deviation value, a standard deviation for the entire basin is calculated based on the standard deviations for the wells in the group, for example using known techniques.

In some examples, the standard deviation for the basin may be used to calculate or determine a standard deviation for a given package of wells (e.g., a subset) in the basin. In a first example, a standard deviation for a package of wells in the basin is determined as follows:

$${σ}_{p a c k a g e} = \sqrt{\frac{{\sum }_{n = 1}^{N} {V}_{n}^{2}}{{( {\sum }_{n = 1}^{N} {V}_{n} )}^{2}}} \cdot {σ}_{b a s i n}$$

In particular, the standard deviation for a package of wells in the basin is calculated by multiplying the standard deviation of the basin by the square root of the sum of squares of a production volume metric of each of the wells in the package divided by the square of the sums of the production volume metrics of the wells in the package.

In one case, the production volume metric is a gross n-year volume equivalent forecast. In particular, an n-year cumulative volume forecast is determined for each well in the package on a barrel of oil equivalent (BOE) basis. For example, the gross n-year volume equivalent forecast is equal to the projected n-year cumulative oil production for the well plus the projected n-year cumulative gas production for the well divided by approximately 5.8.

In a second case, the production volume metric is a gross n-year volume revenue. In particular, rather than converting oil and gas volumes to an equivalent oil barrel for each well in the package, the effective volume used in the accuracy (e.g., standard deviation) calculation described above is based on a revenue (e.g., in US dollars) basis. For example, the gross n-year volume revenue is equal to the projected n-year cumulative oil/gas production for the well times the average realized oil/gas price over the n-year period.

In a third case, the production volume metric is a net n-year volume revenue. In particular, this is similar to the gross n-year volume revenue described above, except on a net basis rather than a gross basis. For example, the net n-year volume revenue is equal to the projected n-year cumulative oil/gas production for the well times the average realized oil/gas price over the n-year period times net interest.

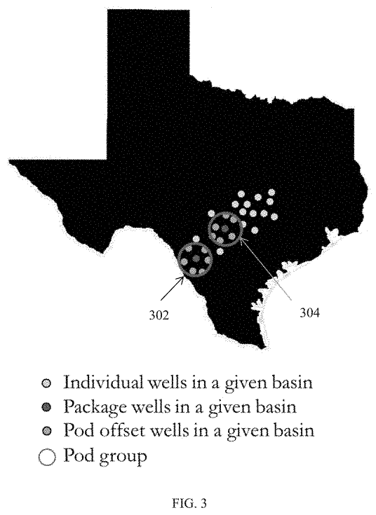

In other examples, the package of wells includes M “pods” or groups of wells. A pod may be a grouping of wells (including offset wells) within a given surface radius distance (e.g., a distance between wellheads of less than a threshold amount). FIG. 3 shows an example of a package of wells being grouped into a first pod 302 and a second pod 304. In an example, grouping wells into a pod is carried out via k-means clustering. A standard deviation is calculated for each pod that includes more than a threshold amount of offset wells, for example more than 10 offset wells. The standard deviation for each pod is given by σ_{Pod m}. For pods that include less than the threshold amount of offset wells, σ_{Pod m} is equal to σ_{basin}, which may be calculated as described above. In the following, the mth pod includes Nₘ wells, and the production volume metric of the nth well in the mth pod is V_{m,n}. Also, in the following, N wells are included in the M pods (e.g., N=N₀+N₁+ . . . +Nₘ), and the production volume metric of one of the N wells is Vₙ. The standard deviation for the package of wells including the M pods is determined as follows:

$${σ}_{p a c k a g e} = \sqrt{\frac{{\sum }_{m = 1}^{M} [ {\sum }_{n = 1}^{{N}_{m}} {V}_{m , n}^{2} \cdot {σ}_{Pod m}^{2} ]}{{( {\sum }_{n = 1}^{N} {V}_{n} )}^{2}}}$$

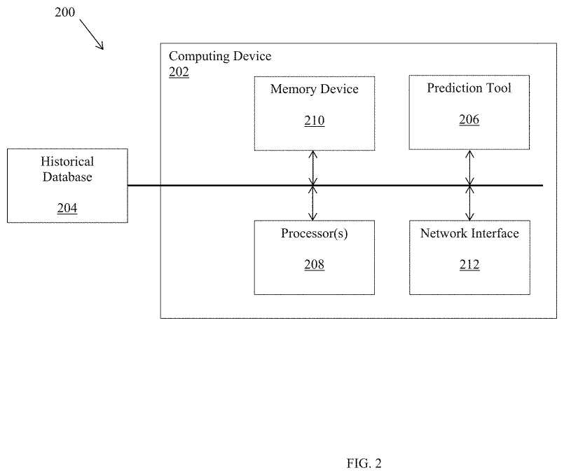

FIG. 2 illustrates, in a generic fashion, the constituent components of an example computing system 200. In the example of FIG. 2, the computing system 200 includes a computing device 202 coupled to a historical database 204. The historical database 204 may include public and/or private databases that contain well parameters 102, described above. The historical database 204 is thus configured to provide well parameters for one or more wells to the computing device 202.

The computing device 202 may be any type of computing device, for example, a desktop computer or workstation, a laptop computer, a server computer, a tablet computer, and the like. As such, computing device 202 includes hardware and software components typically found in a conventional computing device. As shown in FIG. 2, these hardware and software components of computing device 202 include prediction tool 206 that is configured to determine a predicted production decline curve for a given hydrocarbon well, and to determine a prediction accuracy metric for the predicted production decline curve. In this regard, the prediction tool 206 may be implemented as software, hardware, or a combination of both, including the necessary and useful logic, instructions, routines, and algorithms for performing the functionality and processes described in further detail herein.

FIG. 2 also provides an example architecture of computing device 202 according to various embodiments. In this example architecture, computing device 202 includes one or more processors 208, which may be of varying core configurations and clock frequencies as available in the industry. The memory resources of computing device 202 for storing data and/or program instructions for execution by the one or more processors 208 include one or more memory devices 210 (e.g., main memory and/or storage devices), such as non-volatile solid-state memory, magnetic or optical disk drives, or random access memory. The memory devices 210 may store well parameters 102 received from the historical database 204 for use by the prediction tool 206 (e.g., executed on the processor(s) 208). Network interfaces 212, which may be in the form of Ethernet adapters, wireless transceivers, serial network components, etc. are provided to facilitate communication between computing device 202 via one or more networks. In this example architecture, processors 208 are shown as coupled to components 206, 210, 212, as well as to the historical database 204, by way of a single bus; of course, a different interconnection architecture such as multiple, dedicated, buses and the like may be incorporated within computing device 202.

While illustrated as a single computing device, computing device 202 can include several computing devices cooperating together to provide the functionality of a computing device. Likewise, while illustrated as a physical device, computing device 202 can also represent abstract computing devices such as virtual machines and “cloud” computing devices.

As shown in the example implementation of FIG. 2, the computing device 202 includes the prediction tool 206, which may be implemented as a standalone application program, as a program module that is part of another application or program, as the appropriate plug-ins or other software components for accessing the prediction tool software on a remote computer networked with computing device 202 via network interfaces 212, or in other forms and combinations of the same.

The program memory storing the executable instructions of software programs corresponding to the functions of prediction tool 206 may physically reside within computing device 202 or at other computing resources accessible to computing device 202, i.e. within the local memory resources of memory devices 210, or within a server or other network-accessible memory resources, or distributed among multiple locations. In any case, this program memory constitutes a non-transitory computer-readable medium that stores executable computer program instructions, according to which the operations described in this specification are carried out by computing device 202, or by a server or other computer coupled to computing device 202 via network interfaces 212 (e.g., in the form of an interactive application upon input data communicated from computing device 202, for display or output by peripherals coupled to computing device 202). The computer-executable software instructions corresponding to software programs associated with the prediction tool 206 may have originally been stored on a removable or other non-volatile computer-readable storage medium (e.g., a DVD disk, flash memory, or the like), or downloadable as encoded information on an electromagnetic carrier signal, in the form of a software package from which the computer-executable software instructions were installed by computing device 202 in the conventional manner for software installation. It is contemplated that those skilled in the art will be readily able to implement the storage and retrieval of the applicable data, program instructions, and other information useful in connection with this embodiment, in a suitable manner for each particular application, without undue experimentation.

The particular computer instructions constituting software programs associated with the prediction tool 206 may be in the form of one or more executable programs, or in the form of source code or higher-level code from which one or more executable programs are derived, assembled, interpreted or compiled. Any of a number of computer languages or protocols may be used, depending on the manner in which the desired operations are to be carried out. The particular functions of the prediction tool 206 are both described above with respect to FIG. 1, and also in further detail below.

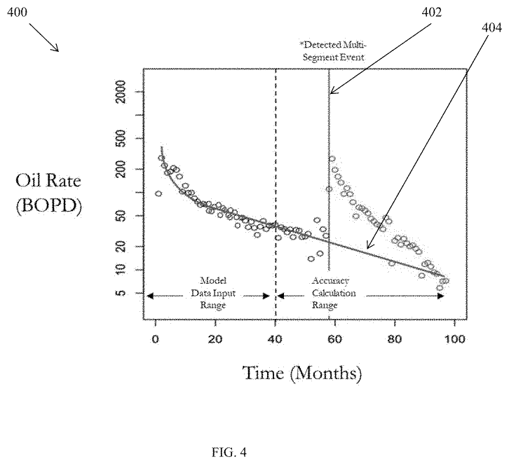

As explained above, the data preparation engine 104 may be configured to determine a break between segments of a multi-segment historical production dataset. In some examples, such a break or deviation is caused by fracking or re-fracking the hydrocarbon well, which results in a rapid and/or sudden change in production level of the well. FIG. 4 shows a graphical example 400 in which a detected multi-segment event (e.g., re-fracking) occurs at time 402. In the example of FIG. 4, the time 402 is after a data input range or time period (e.g., the data from which period is used to generate a predicted production curve 404, such as for an accuracy determination as described above). In some cases, wells for which a multi-segment event occurs outside of the data input range or time period are categorized separately, and accuracy metrics (e.g., standard deviation values) for such wells are also calculated and grouped separately. The accuracy metric for the example of FIG. 4 is generally lower (e.g., farther from a value of 1) than would be expected for a well that does not include a multi-segment event because of the larger discrepancy between the predicted production curve 404 and the historical data following the multi-segment event at time 402. Thus, by categorizing such wells separately, the generally lower accuracy metric does not influence the combined accuracy metric of wells that do not include multi-segment events.

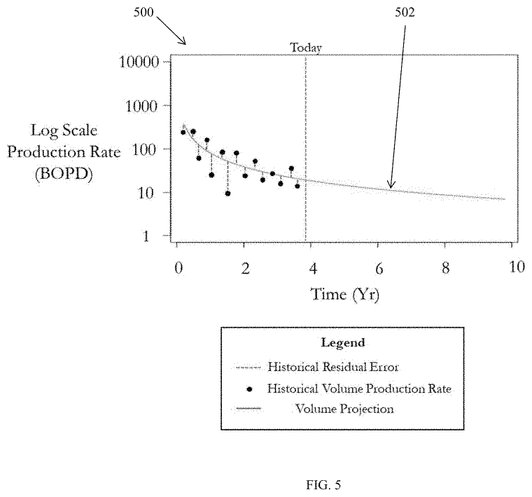

As explained above, the production prediction engine 106 is configured to numerically solve for values of certain parameters (e.g., qi, Di, b, and Df) to reduce or minimize the error between the historical data provided by the data preparation engine 104 and a historical portion of the decline curve. FIG. 5 shows a graphical example 500 of the historical volume production rate data and the residual error between such data and a predicted production decline curve 502. For example, the production prediction engine 106 selects values of qi, Di, b, and Df that generate the decline curve 502 for a time period before a current time (e.g., “today”). As shown, historical volume production rate data is available for the time period before the current time. The production prediction engine 106 minimizes or reduces the residual errors between the generated decline curve 502 and the historical data. The values of qi, Di, b, and Df that result from this process may then be used to generate the predicted production data, or decline curve, that begins at a given start date (e.g., today) and continues until a given end date, or beyond.

As described above, the backtesting engine 108 is configured to determine an accuracy metric for a predicted production decline curve (e.g., provided by the production prediction engine 106) for a well based on a comparison of a predicted production decline curve for a time period (e.g., in the past) with historical production data for that well for the same time period.

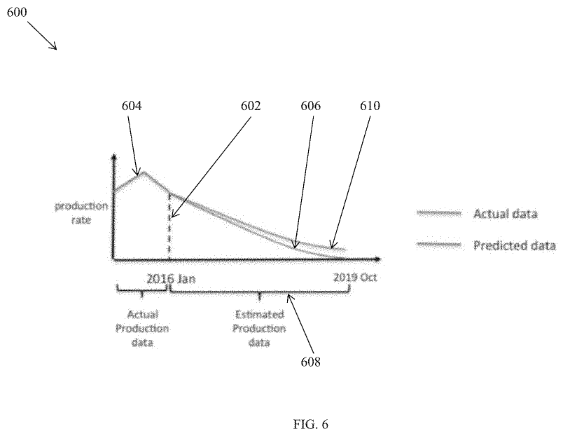

FIG. 6 shows a graphical example 600 of the function of the backtesting engine 108 in accordance with various examples. In this example, the start date 602 is January 2016 (e.g., a date or time in the past). Well parameters 102 are available (e.g., historical production data 604 exists) for dates prior to January 2016 as shown. The production prediction engine 106 is configured to generate a predicted production decline curve 606 well using the historical data 604 (e.g., from the data preparation engine 104) prior to the start time 602. In this example, the end date or time is October 2019, which may be a date or time up to and including the present as described above. Thus, the predicted production decline curve 606 generated by the production prediction engine 106 is for a time period 608—bounded by the start and end dates—for which historical data 610 (e.g., well parameters 102) are also available.

The backtesting engine 108 compares the predicted production decline curve 606 with the corresponding (e.g., occurring at the same time) historical production data 610 from the same time period 608. The backtesting engine 108 generates or determines the prediction accuracy metric based on the comparison of the predicted production decline curve 606 with the corresponding historical production data 610 from the same time period 608. Thus, the accuracy metric may be used to validate or provide a confidence level in the predicted production data provided by the production prediction engine 106.

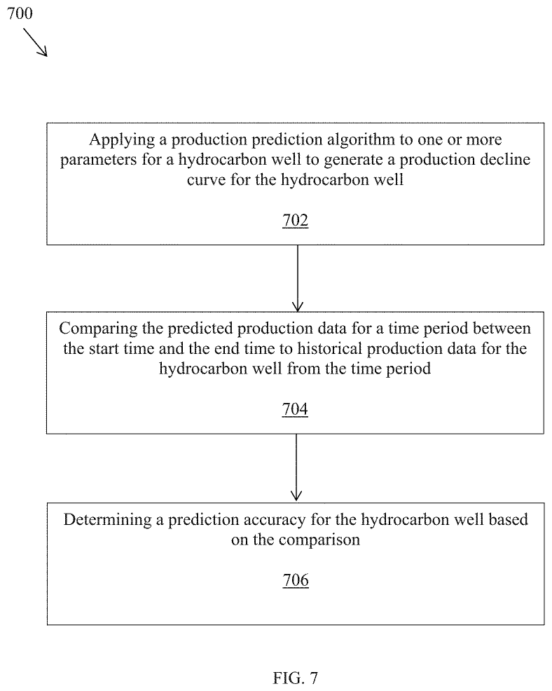

FIG. 7 is a flow chart of a method 700 in accordance with examples of this description. The method 700 begins in block 702 with applying a production prediction algorithm to one or more parameters for a hydrocarbon well to generate a production decline curve for the hydrocarbon well. The production prediction algorithm has a start time and an end time, and the production decline curve comprises predicted production data. As explained above, in an example, the production prediction engine 106 generates a production decline curve (e.g., including predicted production data) in response to cleaned historical data (e.g., from the data preparation engine 104). In one example, the production decline curve is generated by fitting an Arps equation to historical production data. The result of applying the Arps equation is the predicted production decline curve, which forecasts oil and/or gas production volumes going forward from a particular start date, based on historical data from prior to the start date.

The method 700 continues in block 704 with comparing the predicted production data for a time period between the start time and the end time to historical production data for the hydrocarbon well from the time period. The method 700 also continues in block 706 with determining a prediction accuracy for the hydrocarbon well based on the comparison. As explained above, in an example, the backtesting engine 108 is configured to compare the predicted production decline curve with the corresponding (e.g., occurring at the same time) historical production data from the same time period. A prediction accuracy is generated or determined based on the comparison of the predicted production decline curve with the corresponding historical production data from the same time period. Thus, the accuracy metric may be used to validate or provide a confidence level in the predicted production data provided by the production prediction engine 106.

The above discussion is meant to be illustrative of various principles and embodiments of the present disclosure. While certain embodiments have been shown and described, modifications thereof can be made by one skilled in the art without departing from the spirit and teachings of the disclosure. The embodiments described herein are exemplary only, and are not limiting. Accordingly, the scope of protection is not limited by the description set out above, but is only limited by the claims which follow, that scope including all equivalents of the subject matter of the claims.

What is claimed is:

1. A method, comprising:
applying a production prediction algorithm to one or more parameters for a hydrocarbon well to generate a production decline curve for the hydrocarbon well, wherein the production prediction algorithm has a start time and an end time, and wherein the production decline curve comprises predicted production data;
comparing the predicted production data for a time period between the start time and the end time to historical production data for the hydrocarbon well from the time period; and
determining a prediction accuracy metric for the hydrocarbon well based on the comparison.

2. The method of claim 1, further comprising removing the hydrocarbon well from an asset package of hydrocarbon wells responsive to the prediction accuracy metric being below a threshold value.

3. The method of claim 1, further comprising including the hydrocarbon well in an asset package of hydrocarbon wells responsive to the prediction accuracy metric being above a threshold value.

4. The method of claim 3, wherein the threshold value is a first threshold value, the method further comprising including the hydrocarbon well in a lower-risk tranche of the asset package responsive to the prediction accuracy metric being above a second threshold value greater than the first threshold value.

5. The method of claim 1, further comprising:
modifying the production prediction algorithm responsive to the predicted production data and the prediction accuracy metric;
applying the modified production prediction algorithm to the one or more parameters for the hydrocarbon well to generate a modified production decline curve for the hydrocarbon well, wherein the modified production decline curve comprises modified predicted production data;
comparing the modified predicted production data for the time period to the historical production data; and
determining a modified prediction accuracy metric based on the comparison.

6. The method of claim 1, further comprising ceasing production of the hydrocarbon well responsive to the prediction accuracy metric being above an accuracy threshold value and a future predicted production volume being below a production threshold value.

7. The method of claim 1, wherein the hydrocarbon well is a first hydrocarbon well, the production decline curve is a first production decline curve comprising first predicted production data, the start time is a first start time, the end time is a first end time, the time period is a first time period, and the prediction accuracy metric is a first prediction accuracy metric, the method further comprising:
applying the production prediction algorithm to parameters for a second hydrocarbon well to generate a second production decline curve for the second hydrocarbon well, wherein the production prediction algorithm applied to the second hydrocarbon well has a second start time and a second end time, and wherein the second production decline curve comprises second predicted production data;
comparing the second predicted production data for a second time period between the second start time and the second end time to historical production data for the second hydrocarbon well from the second time period;
determining a second prediction accuracy metric for the second hydrocarbon well based on the comparison; and
determining a package prediction accuracy metric for a package of wells including the first and second hydrocarbon wells based on the first prediction accuracy metric and the second prediction accuracy metric.

8. The method of claim 7, wherein determining the package prediction accuracy metric further comprises:
determining a basin prediction accuracy metric for wells in a hydrocarbon basin, wherein the package of wells is a subset of the wells in the hydrocarbon basin;
dividing a sum of squares of a production volume metric of each of the wells in the package of wells by a square of sums of the production volume metrics of the wells in the package of wells;
taking a square root of the result of the dividing; and
multiplying the basin prediction accuracy metric by the square root;
wherein the product of multiplying is the package prediction accuracy metric.

9. The method of claim 7, wherein the package of wells includes M pods of wells, and determining the package prediction accuracy metric further comprises:
determining a pod prediction accuracy metric for each of the M pods;
wherein the package prediction accuracy metric is given by:
$${σ}_{p a c k a g e} = \sqrt{\frac{{\sum }_{m = 1}^{M} [ {\sum }_{n = 1}^{{N}_{m}} {V}_{m , n}^{2} \cdot {σ}_{Pod m}^{2} ]}{{( {\sum }_{n = 1}^{N} {V}_{n} )}^{2}}}$$
wherein an mth pod includes Nm wells, and a production volume metric of the nth well in the mth pod is Vm,n.

10. A system, comprising:
a processor; and
a storage device coupled to the processor, the storage device configured to store instructions that, when executed by the processor, configure the processor to:
apply a production prediction algorithm to one or more parameters for a hydrocarbon well to generate a production decline curve for the hydrocarbon well, wherein the production prediction algorithm has a start time and an end time, and wherein the production decline curve comprises predicted production data;
compare the predicted production data for a time period between the start time and the end time to historical production data for the hydrocarbon well from the time period; and
determine a prediction accuracy metric for the hydrocarbon well based on the comparison.

11. The system of claim 10, wherein the instructions, when executed by the processor, further configure the processor to remove the hydrocarbon well from an asset package of hydrocarbon wells responsive to the prediction accuracy metric being below a threshold value.

12. The system of claim 10, wherein the instructions, when executed by the processor, further configure the processor to include the hydrocarbon well in an asset package of hydrocarbon wells responsive to the prediction accuracy metric being above a threshold value.

13. The system of claim 10, wherein the instructions, when executed by the processor, further configure the processor to:
modify the production prediction algorithm responsive to the predicted production data and the prediction accuracy metric;
apply the modified production prediction algorithm to the one or more parameters for the hydrocarbon well to generate a modified production decline curve for the hydrocarbon well, wherein the modified production decline curve comprises modified predicted production data;
compare the modified predicted production data for the time period to the historical production data; and
determine a modified prediction accuracy metric based on the comparison.

14. The system of claim 10, wherein the hydrocarbon well is a first hydrocarbon well, the production decline curve is a first production decline curve comprising first predicted production data, the start time is a first start time, the end time is a first end time, the time period is a first time period, and the prediction accuracy metric is a first prediction accuracy metric, and wherein the instructions, when executed by the processor, further configure the processor to:
apply the production prediction algorithm to parameters for a second hydrocarbon well to generate a second production decline curve for the second hydrocarbon well, wherein the production prediction algorithm applied to the second hydrocarbon well has a second start time and a second end time, and wherein the second production decline curve comprises second predicted production data;
compare the second predicted production data for a second time period between the second start time and the second end time to historical production data for the second hydrocarbon well from the second time period;
determine a second prediction accuracy metric for the second hydrocarbon well based on the comparison; and
determine a package prediction accuracy metric for a package of wells including the first and second hydrocarbon wells based on the first prediction accuracy metric and the second prediction accuracy metric.

15. The system of claim 14, wherein the instructions, when executed by the processor, further configure the processor to:
determine a basin prediction accuracy metric for wells in a hydrocarbon basin, wherein the package of wells is a subset of the wells in the hydrocarbon basin;
divide a sum of squares of a production volume metric of each of the wells in the package of wells by a square of sums of the production volume metrics of the wells in the package of wells;
take a square root of the result of the dividing; and
multiply the basin prediction accuracy metric by the square root;
wherein the product of multiplying is the package prediction accuracy metric.

16. The system of claim 14, wherein the package of wells includes M pods of wells, and wherein the instructions, when executed by the processor, further configure the processor to:
determine a pod prediction accuracy metric for each of the M pods;
wherein the package prediction accuracy metric is given by:
$${σ}_{p a c k a g e} = \sqrt{\frac{{\sum }_{m = 1}^{M} [ {\sum }_{n = 1}^{{N}_{m}} {V}_{m , n}^{2} \cdot {σ}_{Pod m}^{2} ]}{{( {\sum }_{n = 1}^{N} {V}_{n} )}^{2}}}$$
wherein an mth pod includes Nm wells, and a production volume metric of the nth well in the mth pod is Vm,n.

17. A non-transitory computer-readable medium encoded with instructions that, when executed, cause a processor to be configured to:
apply a production prediction algorithm to one or more parameters for a hydrocarbon well to generate a production decline curve for the hydrocarbon well, wherein the production prediction algorithm has a start time and an end time, and wherein the production decline curve comprises predicted production data;
compare the predicted production data for a time period between the start time and the end time to historical production data for the hydrocarbon well from the time period; and
determine a prediction accuracy metric for the hydrocarbon well based on the comparison.

18. The non-transitory computer-readable medium of claim 17, wherein the instructions, when executed by the processor, further configure the processor to remove the hydrocarbon well from an asset package of hydrocarbon wells responsive to the prediction accuracy metric being below a threshold value.

19. The non-transitory computer-readable medium of claim 17, wherein the instructions, when executed by the processor, further configure the processor to include the hydrocarbon well in an asset package of hydrocarbon wells responsive to the prediction accuracy metric being above a threshold value.

20. The non-transitory computer-readable medium of claim 17, wherein the hydrocarbon well is a first hydrocarbon well, the production decline curve is a first production decline curve comprising first predicted production data, the start time is a first start time, the end time is a first end time, the time period is a first time period, and the prediction accuracy metric is a first prediction accuracy metric, and wherein the instructions, when executed by the processor, further configure the processor to:
apply the production prediction algorithm to parameters for a second hydrocarbon well to generate a second production decline curve for the second hydrocarbon well, wherein the production prediction algorithm applied to the second hydrocarbon well has a second start time and a second end time, and wherein the second production decline curve comprises second predicted production data;
compare the second predicted production data for a second time period between the second start time and the second end time to historical production data for the second hydrocarbon well from the second time period;
determine a second prediction accuracy metric for the second hydrocarbon well based on the comparison; and
determine a package prediction accuracy metric for a package of wells including the first and second hydrocarbon wells based on the first prediction accuracy metric and the second prediction accuracy metric.
